(19) United States
(12) Patent Application Publication
(10) Pub. No.: US 2021/0046675 A1
(43) Pub. Date: Feb. 18, 2021

(54) CAST TOOLING AND METHODS FOR CASTING TOOLS

(71) Applicant: 3M INNOVATIVE PROPERTIES COMPANY, St Paul, MN (US)

(72) Inventors: Charles W. Hedley, Hudson, WI (US); Donald A. Eckstein, Danville, IN (US); Jay A. Esch, River Falls, WI (US); Christopher Kelton, Hudson, WI (US); Fredrick W. Vance, Westfield, IN (US)

(21) Appl. No.: 16/956,264

(22) PCT Filed: Apr. 19, 2019
(86) PCT No.: PCT/IB19/53278

§ 371 Date: Jun. 19, 2020

Related U.S. Application Data
(60) Provisional application No. 62/659,956, filed on Apr. 19, 2018.

(51) Int. Cl. B29C 33/38; B33Y 80/00; B21D 37/20

(52) U.S. Cl. CPC B29C 33/3892; B29L 2031/757; B21D 37/20; B33Y 80/00

(57) ABSTRACT

Disclosed are methods related to making a stamped article and articles and assemblies made therefrom. The methods include providing a partial replica of the stamped article having opposed first and second major surfaces, and then coupling the partial replica to a walled enclosure to provide a mold assembly having upper and lower chambers separated from each other by the partial replica. Compositions can be hardened in the upper and lower chambers to provide upper and lower tools having a shape complemental to the first and second major surfaces. After removing the upper and lower tools from the mold assembly, a deformable sheet can be pressed between the upper and lower tools to form the stamped article.

### FIELD OF THE INVENTION

Provided herein are methods of making tooling useful in a stamping process, along with stamped articles and assemblies thereof.

### BACKGROUND

Stamping is a common way to manufacture flat parts with three-dimensional contours. In this process, a malleable flat sheet is formed into a desired shape by a stamping press comprised of two halves. Each half of the stamping press represents a tool having a face that complemental the surface of the finished part. One half is mounted to the upper platen of a press and the other half mounted to the lower platen. When the press closes, the halves come together and the material being formed assumes the shape of the corresponding tool faces.

While certain applications can be adequately served by flat die-cut parts, others require parts with complex 3-D features to satisfy fit and attachment needs. These applications can be good candidates for stamping, whose versatility has enabled its use in making specialized parts in diverse industrial applications. For stamped articles that are relatively soft and easily formed, tooling options can be quite diverse.

Press tooling, for example, can be made from a wide variety of materials and can be made in different ways. Subtractive processes, such as milling, are well known and can be used to create tools. Machining metal is a traditional means of creating stamping tooling. In certain applications, such as manufacture of parts made from low stiffness materials (e.g. polymers, light sheet metal), other solutions can be more cost efficient. Machined thermoset urethane is one type of material commonly used in metal forming operations, offering lower costs and relatively easy manufacturing compared to metal tools, but with very good durability.

Tooling can also be made by casting polymers and building tooling from laminated, reinforced polymers. Typically using a pattern representing one side of the part to be formed, polymer is cast or laminated over it to build up a thickness. This process would be repeated with a pattern replicating the other side of the part to create the other side of the tool. When complete the resulting halves align to create the part geometry with a cavity that matches the thickness of the material being formed.

As an alternative to making patterns of both halves of the part, it is also possible to place material into a first tool created to simulate the part and cast or laminate the second tool over the filler material, thus creating the tool cavity that forms the part.

### SUMMARY

The provided process is the use of a dual-sided pattern suspended in an enclosure that allows both sides of a matched tool to be cast sequentially using a single setup. The setup can include a plurality of interlocking parts, at least some of which can be made by an additive manufacturing process. Using additive manufacturing to create the pattern allows for very complex shapes to be accurately created and easily assembled into casting molds.

In some embodiments, these processes can be used to make a composite heat shields, such as used in passenger vehicles and commercial trucks. A heat shield, for example, can be made from a urethane foam layer sandwiched between two thin aluminum foil layers.

In a first aspect, a method of making a stamping tool is provided. The method comprises: providing a partial replica of the stamped article having opposed first and second major surfaces; coupling the partial replica to a walled enclosure to provide a mold assembly having upper and lower chambers, the partial replica separating the upper and lower chambers from each other; hardening a first composition in the upper chamber to provide an upper tool with a shape complemental to the first major surface; hardening a second composition in the lower chamber to provide a lower tool with a shape complemental to the second major surface; and removing the upper and lower tools from the mold assembly to obtain the stamping tool.

In a second aspect, a method of making a stamped article from the above stamping tool is provided, in which the method comprises pressing a deformable sheet between the upper and lower tools to form the stamped article.

In a third aspect, a stamping tool is provided using the aforementioned method.

In a fourth aspect, a stamped article is provided using the aforementioned method.

### BRIEF DESCRIPTION OF THE DRAWINGS

FIG. 1 is an exploded perspective top view of a mold assembly according to one embodiment.

FIG. 2 is an exploded perspective bottom view of the mold assembly of FIG. 1.

FIG. 3 is a perspective top view of the mold assembly of FIGS. 1-2 as assembled.

FIG. 4 is a perspective bottom view of the mold assembly of FIGS. 1-3 as assembled.

FIG. 5 is a side view of upper and lower tools obtained from the mold assembly of FIGS. 1-4.

FIG. 6 is a top view of a stamped article made using the upper and lower tools of FIG. 5.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DEFINITIONS

As used herein:

“ambient conditions” means at 25° C. and 101.3 kPa pressure;

“average” means number average, unless otherwise specified;

“copolymer” refers to polymers made from repeat units of two or more different polymers and includes random, block and star (e.g. dendritic) copolymers;

“cure” refers to exposing to radiation in any form, heating, or allowing to undergo a physical or chemical reaction that results in hardening or an increase in viscosity;

“diameter” refers to the longest dimension of a given object or surface;

“polymer” refers to a molecule having at least one repeating unit;

“substantially” means to a significant degree, as in an amount of at least 50%, 60, 70, 80, 90, 95, 96, 97, 98, 99, 99.5, 99.9, 99.99, or 99.999%, or 100%;

“thickness” means the distance between opposing sides of a layer or multilayered article.

### DETAILED DESCRIPTION

As used herein, the terms “preferred” and “preferably” refer to embodiments described herein that can afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

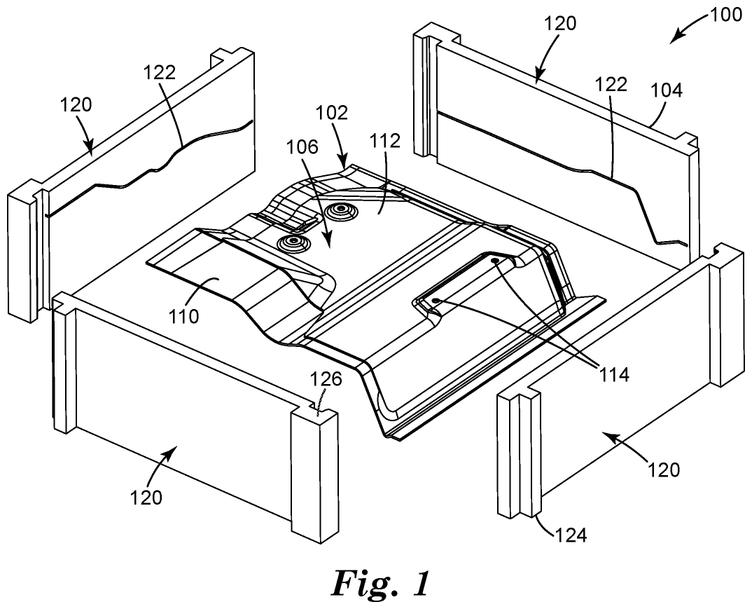

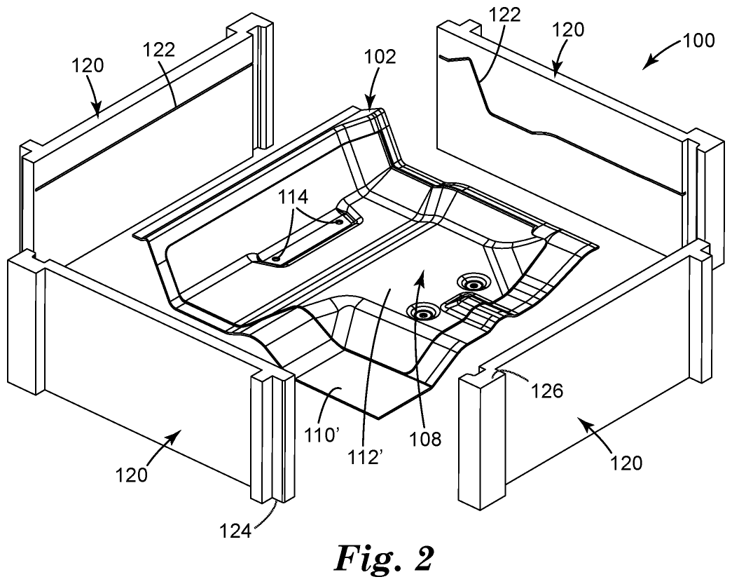

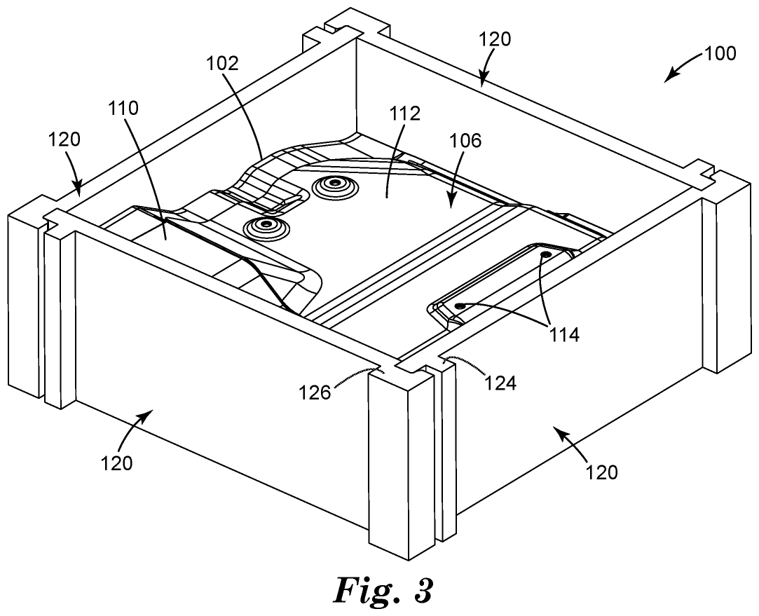

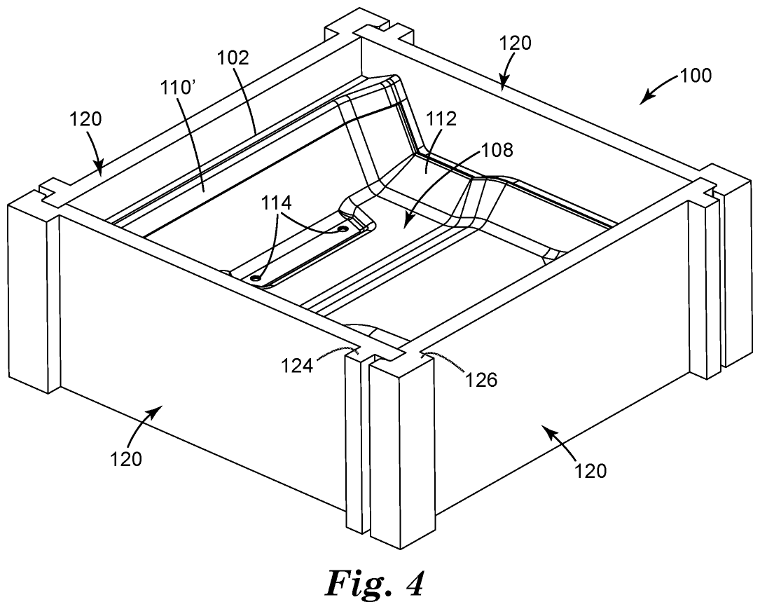

A mold assembly according to one exemplary embodiment is shown according to various views in FIGS. 1-4 and hereinafter referred to by the numeral 100. FIGS. 1-2 show the mold assembly 100 in exploded view for clarity, while FIGS. 3-4 show the mold assembly 100 as assembled. Using the methods described below, the mold assembly 100 is used to fabricate tooling to stamp parts having complex three-dimensional shapes.

The mold assembly 100 generally includes a partial replica 102, which resides in a walled enclosure 104 extending along the periphery of the partial replica 102. Each of these components is described in more detail below.

As shown in the figures, the partial replica 102 is generally flat and contains three-dimensional contours, or features. The partial replica 102 may in some cases have a deep drawn shape, where the depth and height of the three-dimensional features is large relative to the thickness of the partial replica 102. The partial replica 102 has a first major surface 106 visible in the top view of FIG. 1, and an opposing second major surface 108 visible in the bottom view of FIG. 2.

The first and second major surfaces 106, 108 of the partial replica 102 substantially complements, or matches, corresponding first and second major surfaces of the stamped product sought to be manufactured. As a result, a significant, continuous portion of the partial replica 102 has essentially the same shape as a corresponding portion of the stamped product. Where the stamped product is to have a generally uniform thickness, the first and second major surfaces 106, 108 can substantially match each other. In some embodiments, and as shown in FIGS. 1-4, the partial replica 102 is used to form one stamped product at a time. Alternatively, the partial replica 102 may be used to form a plurality of stamped products at a time.

Whether the tool halves derived from the mold assembly 100 are intended to stamp a single part or many parts at once, the partial replica 102 can, and often will, extend over an area larger than the area of the desired stamped product or products. In FIGS. 1-4, the first and second major surfaces 106, 108 include molding regions 112, 112′ and recessed regions 110, 110′ that extend along the periphery of the molding regions 112, 112′, respectively.

The recessed regions 110, 110′ are generally planar, and are recessed relative to adjacent molding regions 112, 112′. Since the partial replica 102 represents a negative mold for the tooling, the recessed regions 110, 110′ correspond to protruding areas on the tooling. Advantageously, these protruding areas can directly impinge against each other to create a tooling cavity when the tooling halves are brought together. The deformable sheet is disposed within the tooling cavity, where it is contacted and shaped by the molding regions 112, 112′ during the stamping process. Advantageously, the protruding areas can function as a positive stop for the tooling during stamping to limit the compression of the deformable sheet.

To provide a positive stop on the resulting tooling, the total depth of the recessed regions 110, 110′ can correspond to the desired thickness of the stamped product. The recessed regions 110, 110′ may be present on either one or both of the first and second major surfaces 106, 108. The recess depth can be at least 2.5 millimeters, at least 3 millimeters, at least 4 millimeters, at least 5 millimeters, or in some embodiments, less than, equal to, or greater than 2.5 millimeters, 3, 3.5, 4, 4.5 or 5 millimeters.

Irrespective of whether recessed regions 110, 110′ are present, the opposing first and second major surfaces 106, 108 of the partial replica 102 can be separated by a thickness of from 1 millimeters to 10 millimeters, 2 millimeters to 9 millimeters, 3 millimeters to 8 millimeters, or in some embodiments, less than, equal to, or greater than 1 millimeter, 1.5, 2, 2.5, 3, 3.5, 4, 4.5, 5, 5.5, 6, 6.5, 7, 7.5, 8, 8.5, 9, 9.5, or 10 millimeters.

In some embodiments, the tooling does not use a positive stop. If so, the depth dimensions set out above can be equivalent to the distance between the opposing first and second major surfaces 106, 108 of the partial replica 102 (i.e., its thickness dimension). This may be the case, for example, when the stamped product itself is used as the partial replica 102 within the mold assembly 100.

Optionally and as shown, the partial replica 102 can have a plurality of registered features that assist in aligning the two halves of the tooling with each other. Here, the partial replica 102 includes a pair of dimples 114 to index the locations of guide pins and respective receptacles (not shown) for such alignment during the stamping process. In one embodiment, the dimples 114 provide bumps on the cast tooling halves which are drilled out in a secondary process to produce cavities that are fitted with guide pins or receptacles after hardening the first and second curable compositions. In some embodiments, the partial replica 102 includes topological features to form registered guide pins and receptacles in the cast tooling directly so a secondary process is not needed.

The walled enclosure 104 is coupled to the partial replica 102 and is bounded by four walls 120 arranged in a generally rectilinear configuration (i.e., the walls 120 meet at right angles). When thus coupled as shown in FIGS. 3 and 4, the partial replica 102 and walled enclosure 104 collectively provide the mold assembly 100 with upper and lower chambers, the partial replica 102 separating the upper and lower chambers from each other.

Optionally and as shown, the walls 120 contain interlocking features 124, 126 that engage with one another. The interlocking features 124, 126 can use, for example, a tongue and groove mechanism as shown in FIGS. 1-4, but need not be so limited. Preferably the interlocking features 124, 126 are releasably interlocking features. Using walls 120 that releasably interlock is advantageous because it facilitates assembly and disassembly of the mold assembly 100 and provides greater consistency in the shape of the mold assembly 100.

The walls 120 can provide a liquid-tight seal against the adjacent partial replica 102, such that the upper and lower chambers do not communicate with each other within the walled enclosure 104. This seal allows a liquid, such as urethane resin or other curable composition, to be poured into walled enclosure 104 without leakage. As shown in FIGS. 1 and 2, grooves 122 receive the peripheral edges of the partial replica 102 when the mold assembly 100 is in assembled form. The grooves 122 assist in improving the quality of the seal and provide additional interlocking features to help secure the partial replica 102 to the walls 120. It is also possible for the grooves to be present on the partial replica 102, where the grooves register with respective protruding features on the walls 120.

The partial replica 102 and walls 120 tend to be highly customized to conform with each other and the final stamped product. Thus, it can be advantageous to fabricate the partial replica 102, walls 120, and/or components thereof by additive manufacturing. If a given partial replica 102 or wall 120 is too large to be fabricated in one piece, two or more smaller parts can be fabricated separately and subsequently fastened together. The two or more smaller parts may be releasably interlocking parts. As another possibility, it is possible for the partial replica 102 and walls 120 to be fabricated as a single unitary component by additive manufacturing.

Examples of additive manufacturing methods include, but are not limited to, three-dimensional printing, selective area laser deposition or selective laser sintering (SLS), electrophoretic deposition, robocasting, fused deposition modeling (FMD), laminated object manufacturing (LOM), stereolithography (SLA) and photostereolithography. Exemplary methods are described, for example, in U.S. Pat. No. 5,340,656 (Sachs et al.), U.S. Pat. No. 5,490,882 (Sachs et al.), and U.S. Pat. No. 5,204,055 (Sachs et al.). Particularly suitable additive manufacturing machines include the VIPER brand SLA system from 3D Systems (Rock Hill, S.C.) or EDEN brand 500V printer from Objet Geometries Ltd. (Rehovot, ISRAEL).

There are many resins suitable for use in additive manufacturing. These resins include, for example, Acrylonitrile Butadiene Styrene (ABS) plastic, Acrylonitrile Styrene Acrylate (ASA) plastic, polylactic acid (PLA) polyetherimide (including polyetheretherketone (PEEK)), nylon, polypropylene, polycarbonate, polyphenylsulfone, along with mixtures and copolymers thereof.

As another option, components of the mold assembly 100 can be made by subtractive manufacturing. For example, it is possible to use CAD-CAM software to direct a milling machine or similar device to fabricate the partial replica 102 and/or walled enclosure 104.

Whether additive or subtractive manufacturing assists in making the partial replica 102 and/or walled enclosure 104, such manufacturing can be directed by 3D digital data. The 3D digital data can represent the final stamped product, or alternatively, the partial replica 102. In some embodiments, the 3D digital data can be virtually constructed on a computer or obtained by scanning a physical object, such as a physical model of the stamped article.

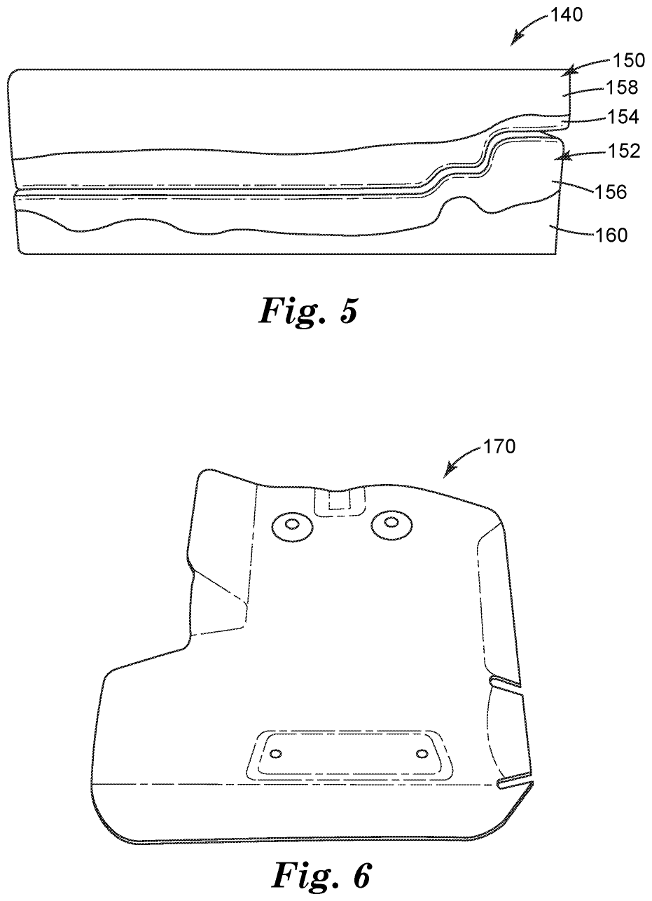

Once made, the mold assembly 100 can be used to make exemplary tooling 140, as shown in FIG. 5. The tooling 140 includes two halves represented here by first and second tools 150, 152, appearing as respective upper and lower tools in the figure. In preparation for casting the halves, the mold assembly 100 can be clamped, fastened, or otherwise secured in its assembled configuration as depicted in FIGS. 3-4. As another option, a release agent may be applied to one or both of the first and second major surfaces 106, 108 at this time in preparation for later removal of the first and second tools 150, 152 from the mold assembly 100.

The casting of the first and second tools 150, 152 in the mold assembly 100 can take place sequentially. The first tool 150 can be formed by pouring and hardening a first composition against the first major surface 106 with the mold assembly 100 oriented as shown in FIG. 3, inverting the mold assembly 100 such that it is oriented as shown in FIG. 4, then pouring and hardening a second composition against the second major surface 108. The first and second compositions can be curable compositions. Alternatively, the compositions may be formed under heat and then hardened by cooling.

After being formed, the first and second tools 150, 152 can be removed from the opposing sides of the mold assembly 100. The mold assembly 100 can be unclamped and disassembled to facilitate removal of the first and second tools 150, 152.

It is to be understood that the order of these above steps need not be critical. For example, the first tool 150 can be removed from the mold assembly 100 prior to forming the second tool 152.

In some embodiments, the first and second curable compositions are essentially the same composition. Alternatively, the first and second curable compositions can have different compositions to yield different mechanical properties in the final tool. Using different compositions can be beneficial in instances where the final stamped product has an asymmetric layer construction that would require different tooling materials—e.g., one surface may be significantly harder or softer than its opposing surface.

Optionally and as shown in FIG. 5, either or both of the first and second tools 150, 152 can include a plurality of discrete layers. The multilayered composition can be prepared, for example, by hardening third and fourth curable compositions adjacent to respective hardened first and second compositions. As shown in FIG. 5, this can be used to provide a configuration in which opposing solid layers 154, 156 are backed by respective porous layers 158, 160. Advantageously, the solid layers 154, 156 provide a smooth, high-fidelity surface that contacts the deformable sheet during a stamping operation. The porous layers 158, 160 can help reduce the overall weight of the tool, as well as provide tolerance to slight misalignments of the press platens.

Use of a multilayered construction can also assist with thermal management to address heat produced during the curing of the curable compositions to form the first and second tools 150, 152. It can be advantageous, for example, to pour the curable compositions into the mold assembly 100 in relatively thin layers, close to the pattern surface, and then allowing these layers to cool before casting subsequent layers to reduce the possibility of pattern distortion. This issue can also be mitigated by using low exotherm resins.

In some embodiments, the solid layers 154, 156 are polyurethane materials. In some embodiments, the porous layers 158, 160 are polyurethane materials that are foamed. Basic components for solid polyurethanes and polyurethane foams include polyether polyols, polyester polyols, and block polymers of polyether and polyester polyols that are reactive with a diisocyanate under the conditions of the foam-forming reaction as well as optional foaming catalysts, surfactants, and antioxidants.

A flexible polyurethane foam can be made by mixing a physical or chemical blowing agent into the resin, or by mixing the polyurethane with a suitable low-density filler. The flexibility of the polyurethane foam can be modified, if desired, by using the isocyanate in less than its stoichiometric amounts. Details of flexible foams are described in “Polyurethanes: Chemistry and Technology, Part II Technology,” J. H. Saunders & K. C. Frisch, Interscience Publishers, 1964, pages 117 to 159. The density of the foams can also be used to obtain a desired firmness.

Alternative curable compositions are also available for the casting of the first and second tools 150, 152. Besides urethane resins, other suitable curable compositions can be derived from phenolic resins, epoxy resins, vinyl ester resins, vinyl ether resins, napthalinic phenolic resins, epoxy modified phenolic resins, silicone (hydrosilane and hydrolyzable silane) resins, polyimide resins, urea formaldehyde resins, methylene dianiline resins, methyl pyrrolidinone resins, acrylate and methacrylate resins, isocyanate resins, unsaturated polyester resins, along with mixtures and copolymers thereof. If desired, any of these curable compositions may be blended with any of a number of solid fillers known in the art to further adjust the mechanical properties after hardening.

The thickness of the first and second tools 150, 152 is preferably sufficient to provide adequate rigidity and avoid significant sagging of the tooling 140 under its own weight. The thickness can also be selected to achieve adequate thermal insulation where the deformable sheet to be stamped is heated.

As mentioned previously, the recessed regions 110, 110′ of the mold assembly 100 create shoulders around the edge of the tool that keep the tool faces from contacting each other when closed, maintaining the necessary clearance to accurately reproduce the parts features and prevent the material from being overcompressed. Maintaining a desired clearance can be particularly important when stamping materials that may contain delicate layers, such as soft foam layers.

FIG. 6 shows a stamped article 170 made using the tooling 140. The stamped article 170 is made be fastening the first and second tools 150, 152 to upper and lower halves of a press platen, optionally aligning the first and second tools 150, 152 with each other and/or with the deformable sheet, and finally pressing the deformable sheet between the first and second tools 150, 152 to form the stamped article.

The deformable sheet is generally planar before being stamped. The composition of the deformable sheet need not be particularly restricted, and may have a single-layer or multilayered construction. Commonly, the deformable sheet includes at least one metal layer made from a malleable metal such as aluminum or stainless steel. In an exemplary multilayered construction, the deformable sheet includes a pair of facing layers made from aluminum disposed on opposing major surfaces of a polymer core layer. The polymer core layer can be comprised of, for example, a polymer foam. An exemplary core has a density of approximately 7 lbs/cubic foot (112 kg/m³) and has a thickness of from 4 to 8 millimeters.

In some embodiments, the stamped article 140 is a heat shield assembly. The heat shield assembly can be useful for passenger vehicles or commercial vehicles. Heat shield assemblies may further include the stamped article 140 coupled to a primary vehicular structure. Advantageously, the provided processes enable heat shields to be customized according to many complex three-dimensional shapes at a reasonable cost.

While not intended to be limiting, further exemplary embodiments are enumerated below:
1. A method of making a stamping tool, the method comprising: providing a partial replica of an article to be stamped, the replica having opposed first and second major surfaces; coupling the partial replica to a walled enclosure to provide a mold assembly having upper and lower chambers, the partial replica separating the upper and lower chambers from each other; hardening a first composition in the upper chamber to provide an upper tool having a shape complemental to the first major surface; hardening a second composition in the lower chamber to provide a lower tool having a shape complemental to the second major surface; and removing the upper and lower tools from the mold assembly to obtain the stamping tool.
2. A method of making a stamped article from the stamping tool of embodiment 1, the method comprising pressing a deformable sheet between the upper and lower tools of the stamping tool to form the stamped article.
3. The method of embodiment 1 or 2, wherein the upper and lower chambers do not communicate with each other within the walled enclosure.
4. The method of any one of embodiments 1-3, further comprising inverting the mold assembly after hardening the first composition but prior to hardening the second composition.
5. The method of any one of embodiments 1-4, wherein the walled enclosure and partial replica are fabricated as a unitary component.
6. The method of any one of embodiments 1-5, wherein the walled enclosure comprises a plurality of walls that releasably interlock with each other.
7. The method of any one of embodiments 1-6, wherein the walled enclosure comprises a plurality of walls capable of releasably interlocking with the partial replica.
8. The method of embodiment 7, wherein at least some of the plurality of walls include a groove for receiving a peripheral edge of the partial replica.
9. The method of embodiment 7 or 8, wherein the partial replica includes a groove for receiving a protruding feature on at least one wall.
10. The method of any one of embodiments 1-9, wherein the partial replica is at least partially fabricated by additive manufacturing.
11. The method of embodiment 10, wherein the partial replica comprises a plurality of releasably interlocking parts, each part at least partially fabricated by additive manufacturing.
12. The method of any one of embodiments 1-11, wherein the walled enclosure is at least partially fabricated by additive manufacturing.
13. The method of embodiment 12, wherein the walled enclosure comprises a plurality of releasably interlocking walls, each wall at least partially fabricated by additive manufacturing.
14. The method of any one of embodiments 1-13, wherein the partial replica and/or walled enclosure comprises acrylonitrile butadiene styrene (ABS) plastic, polyetherimide, nylon, polycarbonate, polyphenylsulfone, or a mixture or copolymer thereof.
15. The method of any one of embodiments 1-14, wherein at least one of the first and second major surfaces includes a recessed region having a depth corresponding to a desired thickness of the stamped article, the recessed region forming a shoulder on the respective upper or lower tool to limit compression of the deformable sheet when it is pressed.
16. The method of any one of embodiments 1-15, further comprising hardening a third composition in the upper chamber adjacent to the first composition to provide an upper tool having a plurality of layers.
17. The method of embodiment 16, wherein the hardened first composition is solid and the hardened third composition is foamed.
18. The method of embodiment 16 or 17, further comprising hardening a fourth composition in the upper chamber adjacent to the second composition to provide the lower tool with a plurality of layers.
19. The method of embodiment 18, wherein the hardened second composition is solid and the hardened fourth composition is foamed.
20. The method of embodiment 18 or 19, wherein the third composition and/or fourth composition comprises a polyurethane foam.
21. The method of any one of embodiments 1-20, wherein the first composition and/or second composition comprises a polyurethane.
22. The method of any one of embodiments 1-21, further comprising applying a release agent to one or both of the first and second major surfaces prior to hardening the first and second compositions.
23. The method of any one of embodiments 1-22, wherein the walled enclosure comprises a plurality of releasably interlocking walls and further comprising disassembling the walled enclosure to facilitate removal of the upper and lower tools from the mold assembly.
24. The method of any one of embodiments 1-23, wherein the partial replica comprises a plurality of releasably interlocking parts and further comprising disassembling the partial replica to facilitate removal of the upper and lower tools from the mold assembly.
25. The method of any one of embodiments 1-24, wherein the upper or lower tool comprises a guide pin and wherein the opposing upper or lower tool comprises a receptacle complemental to the guide pin for aligning the upper and lower tools with each other.
26. The method of embodiment 25, wherein the guide pin and receptacle are provided on the upper and lower tools after hardening the first and second compositions.
27. The method of any one of embodiments 1-26, wherein the opposing first and second major surfaces of the partial replica substantially match each other.
28. The method of embodiment 27, wherein the opposing first and second major surfaces are separated by a thickness of from 1 millimeters to 10 millimeters.
29. The method of embodiment 28, wherein the opposing first and second major surfaces are separated by a thickness of from 2 millimeters to 9 millimeters.
30. The method of embodiment 29, wherein the opposing first and second major surfaces are separated by a thickness of from 3 millimeters to 8 millimeters.
31. The method of any one of embodiments 1-30, further comprising receiving digital data representing the stamped article or partial replica, wherein the partial replica is fabricated based on the digital data.
32. The method of embodiment 31, wherein the digital data is obtained by scanning a physical model of the stamped article.
33. The method of any one of embodiments 2-32, wherein the deformable sheet comprises: a polymer layer; and a metal layer adhered to a major surface of the polymer layer.
34. The method of embodiment 33, wherein the metal layer is a first metal layer adhered to a first major surface of the polymer layer and wherein the deformable sheet further comprises a second metal layer adhered to a second major surface of the polymer layer.
35. The method of embodiment 33 or 34, wherein the polymer layer comprises a polymer foam layer.
36. A stamping tool made using the method of any one of embodiments 1 and 3-35.
37. A stamped article made using the method of any one of embodiments 2-35.
38. A heat shield assembly comprising the stamped article of embodiment 37 coupled to a primary vehicular structure.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

### Example 1—Formation of a Mold Assembly

Additive manufacturing was employed to prepare a mold assembly analogous to mold assembly 100 in FIG. 1, including a Partial Replica 102 and four interlocking walls 120.

Four separate walls 120 were each printed using an acrylonitrile butadiene styrene (“ABS”; Stratasys, Eden Prairie, Minn.), using a 3D printer. The printer was a Stratasys Fortus 400mc. Each wall 120 included interlock features 124 and 126 for interlocking the four walls at the corners, to form a walled enclosure 104, having wall dimensions of 1.65 in. (4.19 cm) w×18.7 in. (47.2 cm) 1×7.41 (18.8 cm) h, and overall dimensions of 19.7 in. (50.1 cm) w×19.7 in. (50.1 cm) 1×7.41 in. (18.8 cm) h. Each wall 120 was printed to also include a 0.25 in. (0.64 cm) groove 122 designed to match the shape of Partial Replica 102.

A Partial Replica 102 was printed to closely approximate the features and dimensions of a final stamped article, resembling stamped article 170 in FIG. 6. Since the overall dimensions of Partial Replica 102 were larger than the envelope of the 3D printer, Partial Replica 102 was printed by additive manufacturing as four separate pieces of roughly similar size, having interdigitating “finger joints” (not shown) that allowed the four separate pieces to be fitted together, and the finger joints were bonded with a moisture-cured cyanoacrylate adhesive.

Partial Replica 102 was then fitted into the grooves 122 in the four walls 120, and the walls 120 were interlocked to hold the Partial Replica 102 in place. A band clamp (not shown) was applied around the exterior of the four interlocked walls provided additional support to keep the walled enclosure 104 held together firmly.

### Example 2—Formation of Upper and Lower Tools

The Mold Assembly of Example 1 was positioned with mold region 112 facing upwards, and urethane resin was cast in a first lift having a thickness of about 4 cm, which cured exothermically. The urethane resin was a blend of polyether polyols from Carpenter Co., Richmond, Va. and Covestro, Leverkusen, Germany, with surfactants from Evonik Industries, Essen, Germany and catalysts from Shepherd Chemical Co., Norwood, Ohio. The isocyanate was a polymeric diphenylmethane diisocyanate polymer provided by Huntsman Corp., The Woodlands, Tex.

Additional lifts of urethane (6 layers on one side and 5 layers on the other) were applied and allowed to cure exothermically, to form a cast “upper tool” (see “first tool” 150 in FIG. 5). The Mold Assembly was inverted, so that mold region 112′ faced upwards, and formation of a cast “lower tool” (see “second tool” 152 in FIG. 5) was carried out in the same manner. The cast upper and lower tools were manually removed from the Mold Assembly, ready for stamping an article therebetween.

### Example 3—Stamped Heat Shield Article

A generally planar piece (˜45 cm×40 cm) of TUF Shield TS-5475 thermal barrier (Aearo Technologies LLC, Indianapolis, Ind.) was cut to a suitable shape and then stamped between the upper and lower tools from Example 2, using a press platen to apply pressure and obtain a stamped heat shield analogous to the stamped article 170 in FIG. 6. The press force was approximately 4.5 kN, and the forming of the part was finished as soon as the press was fully closed, with no dwell time. The press was closed for about 1-2 seconds.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A method of making a stamping tool, the method comprising:
providing a partial replica of an article to be stamped, the replica having opposed first and second major surfaces;
coupling the partial replica to a walled enclosure to provide a mold assembly having upper and lower chambers, the partial replica separating the upper and lower chambers from each other;
hardening a first composition in the upper chamber to provide an upper tool having a shape complemental to the first major surface;
hardening a second composition in the lower chamber to provide a lower tool having a shape complemental to the second major surface; and
removing the upper and lower tools from the mold assembly to obtain the stamping tool.

2. A method of making a stamped article from the stamping tool of claim 1, the method comprising pressing a deformable sheet between the upper and lower tools of the stamping tool to form the stamped article.

3. The method of claim 1, wherein the upper and lower chambers do not communicate with each other within the walled enclosure.

4. The method of claim 1, further comprising inverting the mold assembly after hardening the first composition but prior to hardening the second composition.

5. The method of claim 1, wherein the walled enclosure comprises a plurality of walls that releasably interlock with each other.

6. The method of claim 1, wherein the walled enclosure comprises a plurality of walls capable of releasably interlocking with the partial replica.

7. The method of claim 6, wherein at least some of the plurality of walls include a groove for receiving a peripheral edge of the partial replica.

8. The method of claim 6, wherein the partial replica includes a groove for receiving a protruding feature on at least one wall.

9. The method of claim 1, wherein the partial replica is at least partially fabricated by additive manufacturing.

10. The method of claim 1, wherein the walled enclosure is at least partially fabricated by additive manufacturing.

11. The method of claim 10, wherein the walled enclosure comprises a plurality of releasably interlocking walls, each wall at least partially fabricated by additive manufacturing.

12. The method of claim 1, wherein at least one of the first and second major surfaces includes a recessed region having a depth corresponding to a desired thickness of the stamped article, the recessed region forming a shoulder on the respective upper or lower tool to limit compression of the deformable sheet when it is pressed.

13. The method of claim 1, wherein the opposing first and second major surfaces of the partial replica substantially match each other.

14. A stamping tool made using the method of claim 1.

15. A stamped article made using the method of claim 2.
